(19) United States
(12) Patent Application Publication
(10) Pub. No.: US 2008/0118675 A1
(43) Pub. Date: May 22, 2008

(54) Marked body of transparent material

(76) Inventor: Christian Teissl, Innsbruck (AT)

Correspondence Address: WENDEROTH, LIND & PONACK, L.L.P., 2033 K STREET N. W., SUITE 800, WASHINGTON, DC, 20006-1021, US

(21) Appl. No.: 12/000,081

(22) Filed: Dec. 7, 2007

Related U.S. Application Data
(63) Continuation of application No. PCT/AT2006/000134, filed on Apr. 4, 2006.

(30) Foreign Application Priority Data
Jun. 9, 2005 (AT) A 979/2005

(51) Int. Cl. B44F 1/10; B05D 1/12

(52) U.S. Cl. 428/29; 427/180

(57) ABSTRACT

Disclosed is a member (1) that is made of transparent material and is provided with at least one marking (3) encompassing nanoparticles. Said marking (3) is embodied so as to be invisible when being illuminated with electromagnetic radiation whose wavelength lies in the visible spectral range while being visible when being illuminated with electromagnetic radiation whose wavelength lies in the invisible spectral range.

The present invention concerns a body of transparent material.

It may be desirable for various reasons for bodies of that kind to be provided with markings which are to be discernible at least under certain circumstances and with the assistance of suitable devices. For example the purpose of the markings can be to indicate a given origin of the body. In that connection markings of that kind are also referred to as forgery protection. The markings however can also have an artistic purpose by for example being in the form of attractive graphics.

Hitherto markings of that kind were generally produced by laser ablation or by a mechanical or chemical action on the transparent material. Such markings suffer from the disadvantage that they are constantly visible and thus affect the appearance of the body. Furthermore it was hitherto difficult to produce multi-colored markings. In order for the markings to be multi-colored, different chemical compounds had to be introduced into the marking, for each individual color. To produce the multi-colored impression it was then necessary to use illumination sources which emit electromagnetic radiation at different wavelengths, in which respect each wavelength had to be matched to one of the chemical compounds used.

The object of the invention is to provide a body of transparent material having a marking which on the one hand influences the optical appearance of the body only under certain conditions and which in addition can be implemented in a simple fashion with a high level of resolution in respect of color and space.

That object is attained by a body having the features of claim 1.

Nanoparticles are particles on the nano scale (that is to say their dimensions are in the nanometer range). In connection with the present invention the term nanoparticle is used to denote a particle which, by virtue of its dimensions, scatters substantially no electromagnetic radiation in the visible spectral range. So that the scattering of electromagnetic radiation is negligible the dimensions of the particles should be smaller than about 1/10, preferably smaller than 1/20 of the wavelength of the electromagnetic radiation. In relation to the shortest wavelength in the visible spectral range (blue) of about 400 nm, that therefore gives an upper limit for the diameter of about 40 nm, preferably about 20 nm.

In the extreme case those nanoparticles involve dimensions of only some atomic diameters and thus only consist of between some 10 and 1000 atoms or molecules. The use of nanoparticles is of great significance for attaining the object according to the invention, for various reasons:

On the one hand, by virtue of their small size, nanoparticles do not scatter any light in the visible spectral range.

On the other hand the nanoparticles can be such that, upon illumination with electromagnetic radiation, the wavelength of which is in the non-visible spectral range, they emit electromagnetic radiation in the visible spectral range. By way of example the nanoparticles can be such that they convert electromagnetic radiation at a higher energy level, such as for example ultraviolet radiation (UV), into electromagnetic radiation at a low energy level, in the visible spectral range, that is to say light. In other words, photoexcitation can be effected by means of non-visible electromagnetic radiation, for example in the near UV range or in the infrared (IR) range. Equally excitation by a combination of UV and IR radiation would be possible.

When using certain nanoparticles (for example those comprising semiconductor materials which are also known by the term semiconductor quantum dots) the small dimensioning provides that quantum effects play a part, which provide for a small emission bandwidth of the emitted radiation. That leads to high color saturation of the emitted light.

In addition the severe spatial limitation can also result in an increase in the energy conversion efficiency (quantum efficiency).

In itself the transparency of the nanoparticles in daylight, that is to say without additional photoexcitation, is adversely affected only by a slight degree of residual absorption of electromagnetic radiation in the visible spectral range (basic coloration). It will be noted however that the UV component in the case of indirect daylight illumination is comparatively slight. That residual absorption can be minimized by selecting nanoparticles whose absorption maxima are in the non-visible spectral range, preferably in the ultraviolet range. Additionally or alternatively the emission spacing between the maximum of absorption and the maximum of emission in the luminescence spectrum can be increased for the same electronic transition by means of the Stokes displacement. As the Stokes displacement in the case of nanoparticles can be above that of macroscopic particles the residual absorption in the visible spectral range and thus the basic coloration can be further greatly reduced or entirely eliminated.

However there also exist nanoparticles, in respect of which absorption and emission take place in mutually decoupled relationship and which are thus spectrally far away from each other (for example FRET).

A further advantage of nanoparticles is represented by the tunability of the emitted wavelength by a variation in the particle size. For example a large wavelength range in respect of the emitted light (and thus the color impression related thereto) can be produced by way of the particle size, the aspect ratio or the particle surface area, when the same nanoparticle material is involved, that is to say with the same chemical prerequisites, that occurring when using only one excitation wavelength. In addition the wavelength of the emitted light can be controlled by the geometry of the nanoparticles which have only few atoms or molecules.

Therefore, in an advantageous embodiment of the invention, it can be provided that a first group of nanoparticles is such that upon illumination with electromagnetic radiation with a wavelength in the non-visible spectral range, they emit visible electromagnetic radiation with a first spectral color and a second group of nanoparticles is such that, upon illumination with the same non-visible electromagnetic radiation, they emit visible electromagnetic radiation with a second spectral color which is different from the first spectral color.

As a very large part of the color spectrum can be implemented by way of an additively weighted combination of at least three colors (for example the RGB model), a further advantageous embodiment of the invention provides that a first group of nanoparticles is such that it can emit red light, a second group of nanoparticles is such that it can emit green light, and a third group of nanoparticles is such that it can emit blue light.

Preferably a further embodiment can provide that the nanoparticles are embedded in a matrix, wherein the resulting refractive index of the matrix (naturally in the optical spectral range) is substantially equal to the refractive index of the transparent material. That measure permits simple application of the nanoparticles (or the nanoparticle-doped matrix) without adversely affecting the optical quality of the transparent material. The matrix material used can be for example hardenable resins. Nanoparticle-doped matrices are already commercially available. A supply source is for example Evident Technologies, USA (http://www.evidenttech.com). To reduce the above-described basic coloration it can be provided that the optical density of the doped matrix is reduced in a suitable fashion, for example by way of the doping or the layer thickness.

A further advantageous feature can provide that the marking includes at least one microhole which is provided in the transparent material and in which nanoparticles are disposed. The light scattering cross-section of the microhole can be reduced by the diameter of the microhole being sufficiently small. Furthermore the light scattering cross-section can be further reduced by the avoidance of edges, that is to say by the formation of round microholes. The viscosity of the matrix provided with the nanoparticles can be matched to the selected dimensioning of the microholes and the material parameters of the transparent medium in order to ensure wetting filling of the holes with the doped matrix. A particular advantage of manufacture of the marking by means of microholes is that markings can be implemented on non-planar (that is to say curved) surfaces in a particularly simple fashion. Although markings according to the invention can also be produced by other production processes (for example lithography or imprint technology) on curved surfaces, that involves a much higher level of complication and expenditure when implementing such production processes.

It is preferably provided that the diameter of the at least one microhole is between 50·10⁻⁶ m and 5·10⁻⁶. With an assumed viewer distance of about 0.2 m that would correspond to an angular magnitude of 1 minute of arc and would thus be below the resolution limit of the human eye.

In principle it can be provided that a marking includes a plurality of approximately regularly arranged microholes. In that case it can advantageously be provided that the microholes are arranged at different spacings relative to each other to avoid diffraction effects.

The microholes can be quite generally produced by various processes in accordance with the state of the art. It would be possible for example for the microholes to be stamped into the transparent material of the body (nano- or micro-imprint technology), as is already used nowadays in the production of CDs. It would equally be possible to produce them by photostructuring, for example by dry etching. Another suitable process is the production of the microholes by laser bombardment (for example laser ablation) of the transparent material of the body.

In order to produce microholes in the interior of the transparent material of the body it can be provided for example that the body includes at least two layers of transparent material which are arranged one upon the other—preferably transparently glued to each other. This embodiment of the invention has the further advantage that it permits spatially encoded color information, in a simple fashion. By way of example it can be provided that the first of the at least two layers has nanoparticles which can emit a first spectral color and the second of the at least two layers has nanoparticles which can emit a second spectral color. The color addition which is required for example in the RGB model can be achieved by the differently colored nanoparticles of the at least two layers being arranged in substantially mutually superposed relationship considered along the surface normal of the layers.

A comparable process in which the gray value of a color component is defined by way of the number (the volume) of the color pigments is represented by the continuous tone process. Although that process has already been used for many decades, it cannot be replaced to date for demanding image reproduction procedures by the modern half tone processes (as are used for example in inkjet printers).

It will be appreciated that, independently of the constitution of the body from individual layers, color encoding could also be implemented in the case of a monolithic body by the arrangement of nanoparticles emitting in different colors, in the same or adjacent microholes.

A particularly preferred embodiment of the invention provides that the marking is made up of individual pixels, wherein each pixel has at least one microhole. That permits a systematic constitution for the marking or markings. It will be appreciated that in that case it can be provided that at least one of the pixels has at least two microholes, wherein arranged in a first of the at least two microholes are nanoparticles which can emit a first spectral color and arranged in a second of the at least two microholes are nanoparticles which can emit a second spectral color which is different from the first spectral color. It can also be provided that the individual pixels are arranged at different spacings relative to each other to avoid diffraction effects.

The body of transparent material can be for example a body of glass or plastic material.

The way in which a multi-colored marking of a glass body can be produced is described hereinafter. It will however be immediately apparent to the man skilled in the art that the procedure described hereinafter is not restricted to glass bodies but can also be employed in relation to other bodies of transparent material such as for example plastic material.

A very large part of the color spectrum can be embodied by way of additively weighted combination of at least three colors (for example the RGB model). In that respect the spectral brightness sensation for day and night vision can be taken into consideration by way of the weighting. A possible option now provides encoding a respective item of color information onto a half of the glass. The third item of color information is disposed in an intermediate layer. That can be for example a further thin glass plate. The information however can also be in a nanoparticle-doped matrix layer of a thickness of some micrometers (μm). That is applied for example by way of a spray process, spatial encoding can be effected for example by way of a mask.

In principle those color layers can also be embodied with the known production processes such as inkjet printing, screen printing, lithography and so forth.

A particularly advantageous process however is described hereinafter. That process affords a possible way of producing a transparent, high-resolution areal structure which is preferably flat but which can also be curved and which emits in true color under non-visible excitation. The body includes at least two layers of transparent material. The at least two layers of transparent material can be joined for example with transparent UV adhesive, in which case the refractive index of the UV adhesive is matched to that of the transparent material of the body. That provides that even a slight light scatter which possibly remains, at the edges of the doped matrix layer, disappears.

The high degree of positional resolution is achieved here by means of microholes. Each microhole is of a diameter which is below the resolution limit of the eye (below 50×10⁻⁶ m at a 200 mm distance or 1 minute of arc). The microholes are filled with a nanoparticle-doped matrix. In that case for example a plane can correspond to one of the three RGB colors. The respective weighting at a location is determined by the volume of the microhole. In that case encoding can be effected in two dimensions, namely over the area and over the depth of the microhole. It will be noted however that a minimum depth should be observed, which for example depends on the waviness of the glass. The maximum depth depends inter alia on the optical density of the doped matrix (for an optically dense matrix a depth of about one wavelength can be sufficient). The logarithmic brightness sensation of the eye can be taken into account in the encoding operation. For photo quality a dynamic range of at least 100 would be necessary, while for slide quality it would be about 1000 (J. D. Foley et al. Grundlagen der Computergraphik, Kapital 11: Achromatisches und farbiges Licht. [“Bases of computer graphics, Chapter 11: Achromatic and colored light”] 1st edition, Addison-Wesley, 1994). The minimum intensity graduation should not be below 64 steps (6-bit), with 512 steps (9-bit) the dynamic range is between photo and slide.

With the addition of a further thin glass plate it is possible for example to expand to the RGB or four colors (for example additional channel for colors outside the color triangle, or for a higher CRI value), with a resolution which remains the same.

Unwanted reabsorption of the emitted visible light of a color layer by another could be prevented by a suitable choice of the color layer sequence. In other words, as seen from the viewer, there first follows the color layer of the shortest wavelength, followed by the color layer of the second shortest wavelength, and so forth. In the RGB model that would signify the following sequence: firstly the blue-emitting color layer, followed by the green-emitting color layer and last the red-emitting color layer.

Preferably excitation is effected from both sides (with a or by means of a plurality of excitation sources, for example a UV LED chip or chips), directly or indirectly (by way of reflection, total reflection, refraction and so forth).

In the case of optically dense layers and with a low level of excitation intensity, possible interference absorption can also be taken into consideration by calculation.

When a layer is applied by way of a spray process (mask, screen printing process and so forth) the weighting or brightness can be predetermined by means of rastering, for example having regard also to error diffusion (see Floyd and Steinberg, An adaptive algorithm for spatial grey scale, in: Society for Information Display 1975, Symposia Digest of Technical Papers 1975, page 36). When using only one mask with for example 10×10 holes (d=5×10⁻⁶ m), that gives a dynamic range equal to 100, wherein the value for the dynamic range approximately corresponds to photo quality, but the intensity steps can already be perceived by the eye.

With that mask procedure, the color quality can further be enhanced by using a plurality of mask-determined color installations.

Another method of applying spatially encoded color information is lithography. In this embodiment the nanoparticles are disposed in a UV hardenable matrix. The layer, which is a few micrometers thick, of the nanoparticle-doped matrix is covered by a mask. Only those layer regions which are UV transmissive in the mask are hardened. The excess matrix material can be carefully removed. That method is particularly suitable for large-area markings with a low demand in terms of color-spatial encoding. For example single-colored texts, patterns or transparent segment displays can be produced in that way on or in a transparent medium (for example glass).

Pre-structuring would also be possible, by means of easily structurable chemical compounds to which nanoparticles specifically surface-prepared for that purpose then adhere or which are avoided by nanoparticles which are specifically surface-prepared for that purpose.

A further possible option would be photolithographic structuring as is used in the semiconductor art.

In quite general terms a body according to the invention of particularly high optical quality is afforded if it is provided that the body is free of structures which absorb or scatter electromagnetic radiation in the visible spectral range.

A process for the production of a body as set forth in the embodiments according to the invention in which the marking includes microholes, includes at least the following steps:
producing the microholes in the transparent material of the body, and
introducing the nanoparticles into the microholes.

As already described hereinbefore the microholes can for example be stamped into the transparent material or produced by laser bombardment of the transparent material or by dry etching.

A particularly simple configuration of the second process step is afforded if it is provided that the nanoparticle-doped matrix is firstly applied over a large area to the surface of the body, for example being sprayed thereon. In that case it is possible to dispense with specific application of the matrix into the microholes. That embodiment avoids the problem of having to apply the doped matrix in point-accurate relationship to the surface.

It can however also be provided that the matrix provided with nanoparticles is printed onto the surface of the body with an inkjet printer. That can be effected either over a large area or targetedly in substantially point-accurate relationship.

A particularly preferred embodiment of the invention provides that the matrix comprises a hardenable material. By way of example it is possible to select a substance which hardens under UV irradiation.

That makes it possible for the matrix to be hardened in the region of each microhole after application to the surface of the transparent body. That can be effected without the UV radiation being used specifically only in the region of each microhole. By way of example it can be provided that the body is irradiated from the side which is remote from the surface bearing the microholes. It can for example be provided that a layer which reflects in a given UV range (and which is transparent in the visible spectral range) is already applied to the surface of the body, in which the microholes are produced, prior to the production of the microholes. As the UV reflecting layer is removed upon production of the microholes, in the region of the microholes, it prevents exclusively the penetration of UV radiation into the parts of the matrix, which are on the body outside the region of the microholes.

A further possibility involves the hardening the matrix which is in the microholes in accurately targeted relationship by means of a UV laser.

In addition the application of an anti-adhesion coating for the doped matrix (which is transparent in the visible spectral range) can be provided as an additional measure. An anti-adhesion coating of that kind reduces the adhesion between the part of the matrix which is outside the microholes, whereby that part can be more easily removed.

In a further variant it can be provided that, after application of the matrix and prior to hardening, a stable or flexible material is applied to and pressed onto the coated surface, with the material having a plurality of preferably through pores. The surface tension of the material and the diameter of the pores is in that case to be so selected that no capillary effect occurs as otherwise material would be sucked out of the microholes. The plurality of pores form passages into which the excess matrix disposed on the surface of the material can penetrate. After the hardening operation the material can be easily removed jointly with the matrix which has penetrated into the passages.

In that respect, the material described, which is provided with pores, could be on the one hand a strong solid material which after cleaning is available again or however a thin flexible membrane which is disposed of after it has been used once.

It can be particularly preferably provided in that respect that the pores do not extend in the direction of the surface normal to the surface but inclinedly relative thereto. That affords an advantageous geometrical shading effect which provides that at most a small part of the matrix which is disposed in the passages hardens in the region of the micropores. In addition an inclined positioning of the pores, upon removal of the material, produces its blade effect if the layer is firstly moved laterally before being lifted off the surface.

Further advantages and details of the invention will be apparent by reference to the specific description and the accompanying Figures in which:

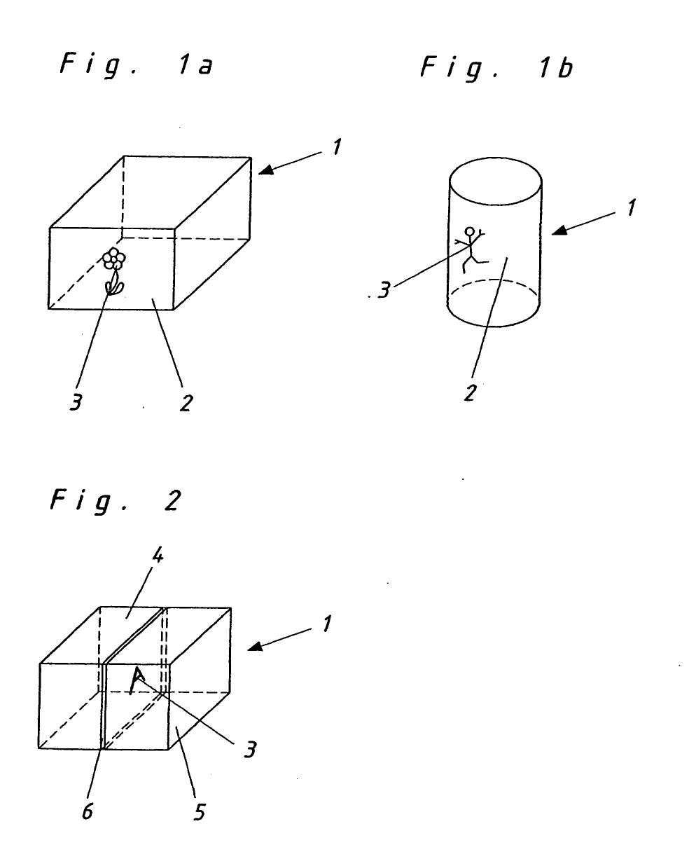

FIGS. 1a and 1b are diagrammatic views of a first and a second embodiment of a body according to the invention,

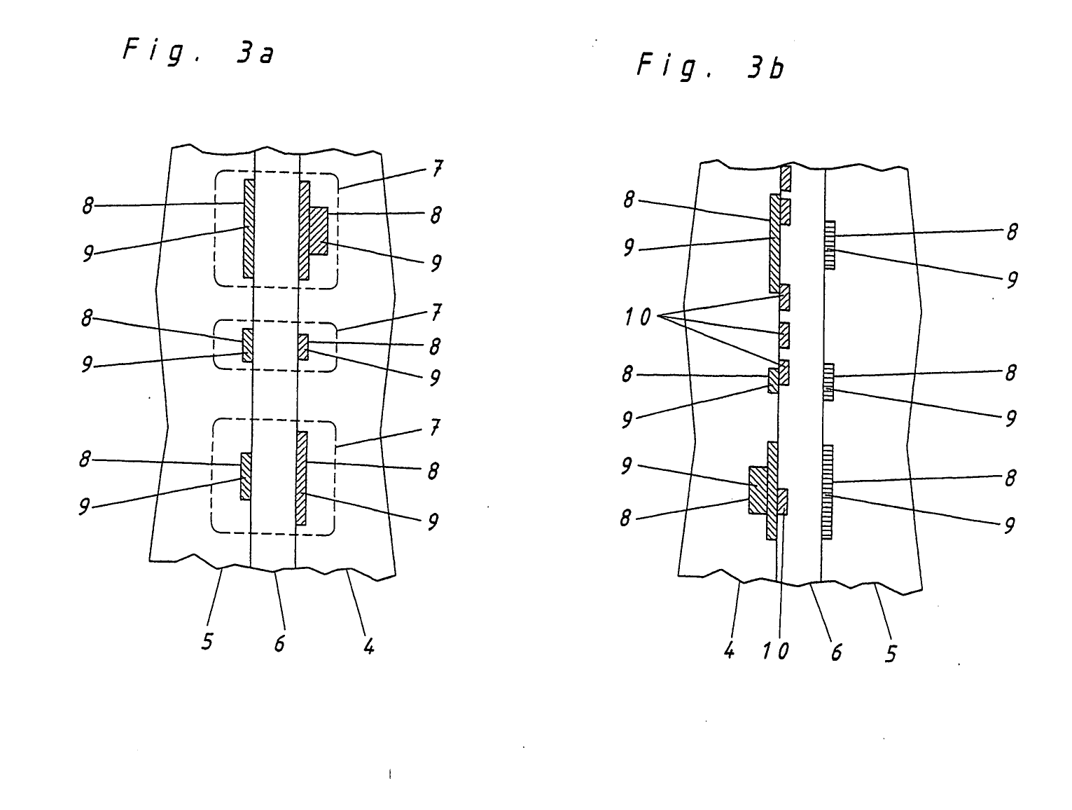

FIG. 2 is a diagrammatic view of a further embodiment of a body according to the invention,

FIGS. 3a and 3b are detail views of the body shown in FIG. 2,

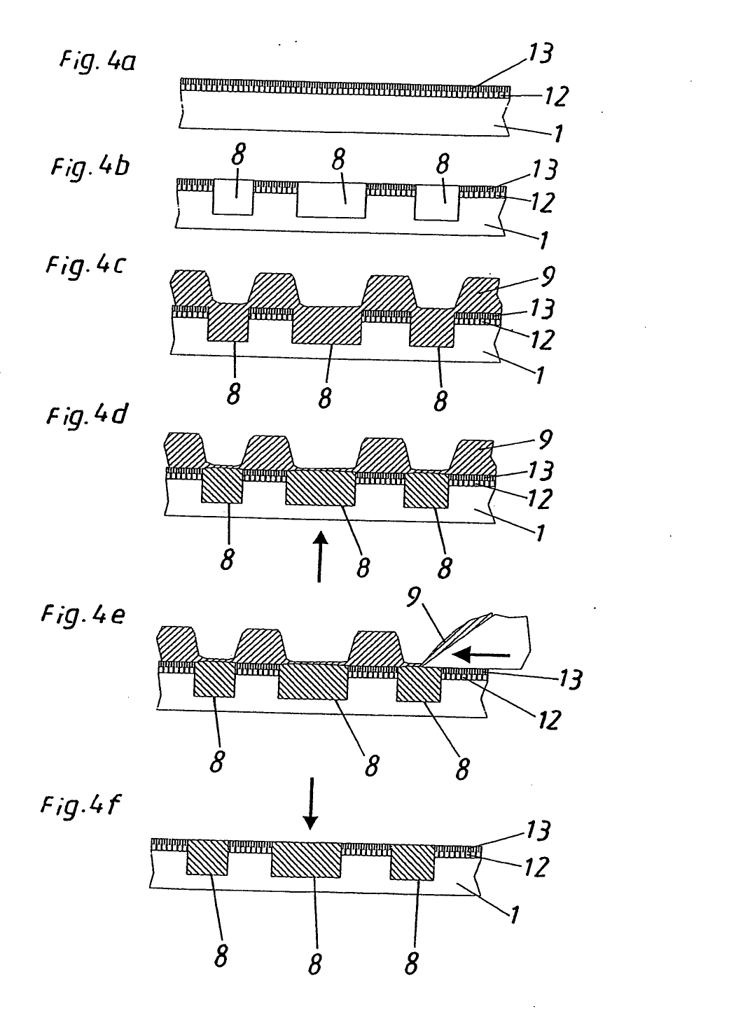

FIGS. 4a-4f show a first embodiment of a process according to the invention for the production of a body according to the invention,

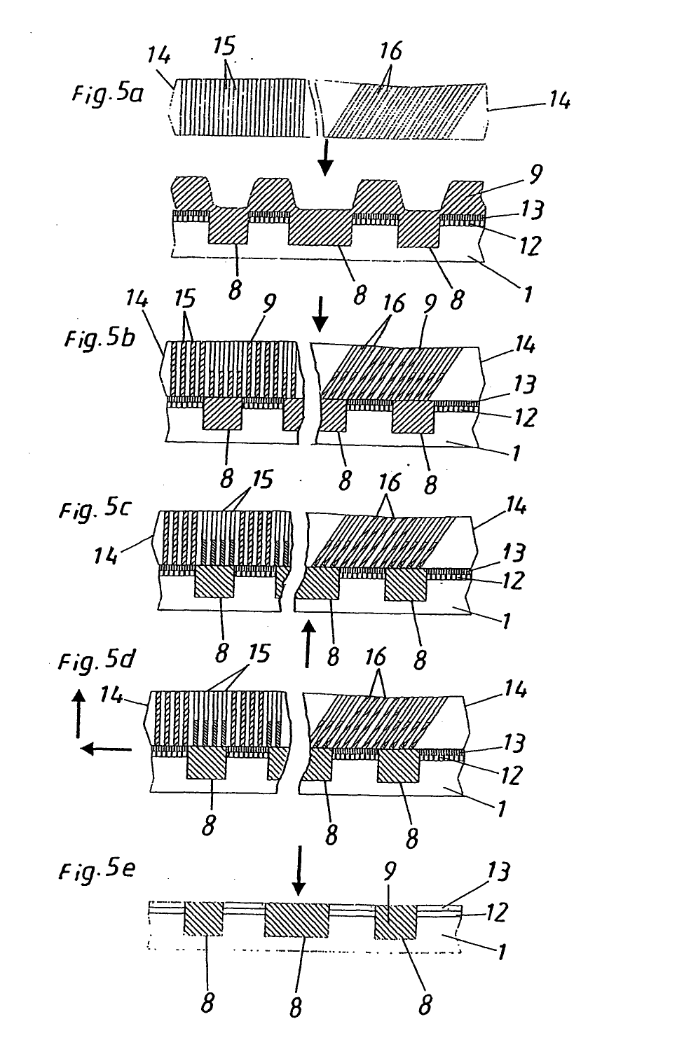

FIGS. 5a-5e show a second embodiment of a process according to the invention for the production of a body according to the invention, and

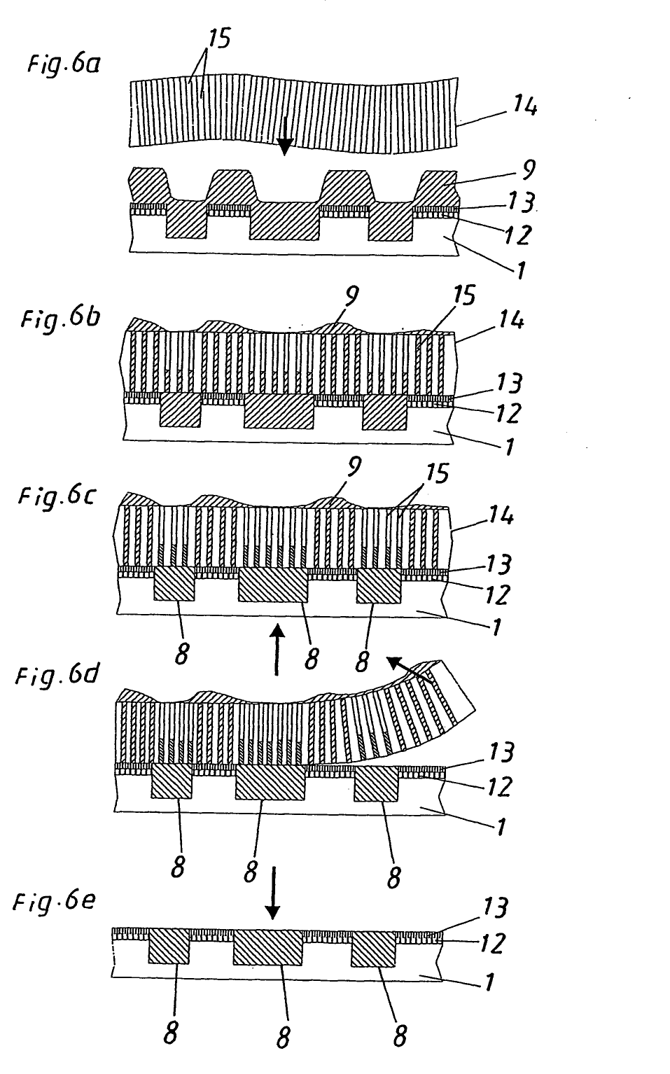

FIGS. 6a-6e show a further embodiment of a process according to the invention for the production of a body according to the invention.

FIG. 1a diagrammatically shows an embodiment of a body 1 according to the invention comprising transparent material, at the surface 2 of which is arranged a marking 3 in the form of an artistic representation. That marking 3 is visible only upon irradiation by electromagnetic radiation in a non-visible spectral range. The source required for that purpose is not shown in FIG. 1a. Without the radiation, the viewer has the impression of a transparent body 1 which does not have any marking 3 at all. FIG. 1b shows a further embodiment of a body 1 according to the invention in the form of a cylinder, wherein the marking 3 is arranged at the curved peripheral surface (surface 2) of the cylinder.

FIG. 2 shows a further embodiment of a body 1 according to the invention comprising two layers 4, 5 which are joined together by way of an adhesive layer 6. A marking 3 which in this embodiment is embodied in the form of text is arranged in the interior of the body 1. In this embodiment also the marking 3 is visible only upon irradiation by electromagnetic radiation of a wavelength in the non-visible spectral range.

FIG. 3a shows a first detail view of the body illustrated in FIG. 2 in the region of the marking 3. It will be seen that the nanoparticle-doped matrix 9 is arranged in microholes 8 in each of the two layers 4, 5. In that case each of the broken-line regions 7 represents a pixel of the marking 3. The adhesive used here for the layer 6 is transmissive for the exciting wavelength. The variant shown in FIG. 3a involves two different colors, wherein only nanoparticles of a first color are arranged in the one layer 4 and only nanoparticles of another color arranged in the other layer 5. A three-color variant is shown in FIG. 3b which illustrates an alternative configuration of the body shown in FIG. 2, in the region of the marking 3. In this embodiment the third color has been sprayed onto the layer 4 by means of a mask. Thereafter the two layers 4, 5 are transparently joined together by the layer 6.

FIGS. 4a-4f show a first embodiment of a process according to the invention for the production of a body 1 according to the invention. In this case—as shown in FIG. 1—it can be provided that the illustrated marking 3 is provided at the surface 2 of the body 1. Alternatively it can also be provided that a first layer 4 and a second layer 5 are produced in accordance with the process shown in FIGS. 4a-4f and they are joined together by an adhesive layer 6, as is shown in FIG. 2.

FIG. 4a shows the starting condition of the process in which a thin UV-reflecting layer 12 which is transparent in the visible spectral range has been optionally applied to the body 1. Optionally a layer 13 has also been applied, which represents an anti-adhesion coating for the nanoparticle-doped matrix 9. As shown in FIG. 4b the microholes 8 are firstly produced. It will be appreciated that both the layer 12 and also the layer 13 are removed thereby, in the region of the microholes 8. As the next step (FIG. 4c) the nanoparticle-doped matrix 9 is applied to the surface of the body 1. That can be effected either for example by spraying, dipping or by spreading it on. That affords the condition shown in FIG. 4c, in which the microholes 8 are filled and a part of the material of the matrix 9 remains on the surface of the body 1. It can advantageously be provided that the body 1 is subjected to a vacuum for some time, in the condition illustrated in FIG. 4c. That can provide that any air bubbles which have possibly remained in the microholes 8 are evaporated out. The next step, as shown in FIG. 4d, involves hardening of the matrix 9 in the region of the microholes 8. In this embodiment that is effected by irradiation with UV radiation from the side of the body 1 which is remote from the surface provided with microholes 8. Hardening of the matrix 9, which is primarily restricted to the regions of the microholes 8, is reinforced in the illustrated embodiment by the additional measure of the layer 12 which reflects the UV radiation away from the matrix 9 everywhere except in the region of the microholes 8. If a matrix 9 which hardens poorly when in contact with oxygen is used, that operation can be carried out in an atmosphere comprising pure oxygen. As shown in FIG. 4e the rest of the matrix material 9 which has not hardened can be removed by a scraper. Post-hardening of the matrix material 9 in the region of the surfaces of the microholes 8 can then be effected. That can be effected for example in a nitrogen atmosphere if a matrix which preferably hardens upon contact with nitrogen is used.

The embodiment shown in FIGS. 5a-5e differs from that shown in FIGS. 4a-4f only in that it uses an additional layer 14 provided with a plurality of pores 15 formed by passages. As illustrated those passages can also be in the form of inclinedly extending pores 16. It can be seen in particular from FIG. 5c that the inclinedly extending pores 16 have the advantage that only a smaller part of the material of the matrix 9 hardens. More specifically, that involves only the part which can be reached by the UV radiation geometrically and by scattering. With pores 15 which extend straight, it can happen that all of the material of the matrix 9 which has penetrated into the pores 15 in the region of the microholes 8 hardens. As shown in FIG. 5d, the inclinedly extending pores 16 additionally have the advantage of a blade effect when, upon removal of the layer 14, it is provided that it is firstly moved laterally along the body 1 and is only then moved away from the body 1.

In a further embodiment as shown in FIGS. 6a-6e the only difference in relation to the process shown in FIG. 5a-5e is that a flexible layer 14 has been used in FIGS. 6a-6e instead of a stiff layer 14. In that case for example it could involve a membrane which is to be used once.

1. A body of transparent material, wherein the body has at least one marking including nanoparticles, wherein the marking is such that, upon illumination with electromagnetic radiation whose wavelength is in the visible spectral range, it is invisible and, upon illumination with electromagnetic radiation whose wavelength is in the non-visible spectral range, it is visible.

2. A body as set forth in claim 1 wherein the marking is such that it is visible exclusively upon illumination with electromagnetic radiation whose wavelength is in the non-visible spectral range.

3. A body as set forth in claim 1 wherein the nanoparticles are such that, upon illumination with electromagnetic radiation whose wavelength is in the non-visible spectral range, they emit electromagnetic radiation in the visible spectral range.

4. A body as set forth in claim 3 wherein a first group of nanoparticles is such that upon illumination with electromagnetic radiation with a wavelength in the non-visible spectral range, they emit visible electromagnetic radiation with a first spectral color and a second group of nanoparticles is such that, upon illumination with the same non-visible electromagnetic radiation, they emit visible electromagnetic radiation with a second spectral color which is different from the first spectral color.

5. A body as set forth in claim 4 wherein
a first group of nanoparticles is such that it can emit red light,
a second group of nanoparticles is such that it can emit green light, and—a third group of nanoparticles is such that it can emit blue light.

6. A body as set forth in claim 1 wherein the nanoparticles are embedded in substantially agglomeration-free manner in a matrix whose resulting refractive index is substantially equal to the refractive index of the transparent material.

7. A body as set forth in claim 1 wherein the marking includes at least one microhole which is provided in the transparent material and in which nanoparticles are disposed.

8. A body set forth in claim 7 wherein the diameter of the microhole (8) is selected to be so small that it is below the resolution limit of the human eye.

9. A body as set forth in claim 7 wherein the diameter of the microhole is less than 5·10⁻⁵ m and larger than 5·10⁻⁶ m.

10. A body as set forth in claim 7 wherein the marking includes a plurality of microholes which are approximately regularly arranged.

11. A body as set forth in claim 10 wherein the microholes are arranged at different spacing relative to each other to avoid diffraction effects.

12. A body as set forth in claim 1 wherein the body includes at least two layers of transparent material which are arranged one upon the other—preferably glued to each other.

13. A body as set forth in claim 12 wherein the first of the at least two layers has nanoparticles which can emit a first spectral color and the second of the at least two layers has nanoparticles which can emit a second spectral color.

14. A body as set forth in claim 13 wherein the nanoparticles of the at least two layers are arranged in substantially mutually superposed relationship considered along the surface normal of the layers.

15. A body as set forth in claim 7 wherein the marking is made up of individual pixels, wherein each pixel has at least one microhole.

16. A body as set forth in claim 15 wherein at least one of the pixels has at least two microholes, wherein arranged in a first of the at least two microholes are nanoparticles which can emit a first spectral color and arranged in a second of the at least two microholes are nanoparticles which can emit a second spectral color which is different from the first spectral color.

17. A body as set forth in claim 11 wherein the first of the at least two microholes is arranged in a first of the at least two layers and the second of the at least two microholes is arranged in a second of the at least two layers.

18. A body as set forth in claim 17 wherein the two microholes are arranged in substantially mutually superposed relationship considered along the surface normals of the layers.

19. A body as set forth in claim 1 wherein the body is at least substantially free of structures which absorb or scatter electromagnetic radiation in the visible spectral range.

20. A process for the production of a body as set forth in claim 1, wherein it includes the following steps:
producing the microholes in the transparent material of the body, and
introducing the nanoparticles into the microholes.

21. A process as set forth in claim 20 wherein the microholes are stamped into the transparent material.

22. A process as set forth in claim 20 wherein the microholes are produced by laser bombardment of the transparent material.

23. A process as set forth in claim 20 wherein the microholes are etched into the transparent material.

24. A process as set forth in claim 20 wherein the matrix provided with nanoparticles is sprayed onto the surface of the body.

25. A process as set forth in claim 20 wherein there are applied to regions of the transparent body chemical compounds to which nanoparticles which are specifically surface-prepared for that purpose then adhere or which are avoided by surface particles which are specifically surface-prepared for that purpose.

26. A process as set forth in claim 24 wherein the matrix is hardened after being applied to the surface of the body in the region of each microhole.

27. A process as set forth in claim 26 wherein excess matrix material which has remained on the surface of the transparent body is removed.

28. A process as set forth in claim 26 wherein a cover layer having a plurality of pores is applied to the surface of the body after application of the matrix to the surface of the body and prior to hardening of the matrix.

29. A process as set forth in claim 20 wherein, prior to the production of the microholes, a layer is applied to the surface of the body, which layer reflects electromagnetic radiation in the spectral range of the hardening wavelength.

30. A process as set forth in claim 20 wherein prior to the production of the microholes, a layer is applied to the surface of the body, which layer involves a greatly reduced bonding to the nanoparticle-doped matrix.
